(19) United States
(12) Patent Application Publication
(10) Pub. No.: US 2023/0192570 A1
(43) Pub. Date: Jun. 22, 2023

(54) A FERTILIZER GRANULE OF POLYHALITE AND MELTED UREA AND A GRANULATION PROCESS FOR THE PRODUCTION THEREOF

(71) Applicant: ICL EUROPE COOPERATIEF U.A., Amsterdam (NL)

(72) Inventor: KHALIL ABU-RABEAH, BEER SHEVA (IL)

(21) Appl. No.: 17/924,999

(22) PCT Filed: May 12, 2021
(86) PCT No.: PCT/IL2021/050548

§ 371 Date: Nov. 13, 2022

Related U.S. Application Data
(60) Provisional application No. 63/029,489, filed on May 24, 2020.

(51) Int. Cl. C05C 9/00; C05G 5/12

(52) U.S. Cl. CPC C05C 9/005; C05G 5/12

(57) ABSTRACT

According to some demonstrative embodiments, there is provided herein a chloride free fertilizer granule comprising a mixture of polyhalite and melt urea in a ratio of between 1:4 to 4:1.

### FIELD OF THE INVENTION

The present invention relates to the field of fertilizers, specifically to production of granulation of Urea and Polyhalite as a complex fertilizer.

### BACKGROUND OF THE INVENTION

To grow properly, plants need nutrients (nitrogen, phosphate, potassium, calcium, zinc, magnesium, iron, manganese, etc.).

Fertilizers are needed to achieve a desired plant growth and they typically provide, in varying proportions, three main macronutrients: N,P and K. Polyhalite is an evaporite mineral, a hydrated sulfate of potassium, calcium and magnesium with formula: K₂Ca₂Mg(SO₄)₄ 2H₂O.

Polyhalite is used as a fertilizer since it contains four important nutrients and is low in chloride:

48% SO3 as sulfate

14% K2O

6% MgO

17% CaO

Nitrogen is essential component for the plant. N containing fertilizers like Urea, ammonium nitrate, ammonium sulphate calcium nitrate and Magnesium nitrate are useful for the plant's growth.

However, despite the potential of using urea as a fertilizer, or at least as a portion thereof, urea has various disadvantages, including for example, rapid breakdown and volatilization which causes substantial loss of urea, and potentially harmful components dissolved into the soil.

The losses can be more than 10% depending on the temperature soil character.

### SUMMARY OF THE INVENTION

According to some embodiments, there is provided herein a fertilizer granule comprising a mixture of polyhalite and melt urea in a ratio of between 20:80 to 80:20

According to some embodiments, the ratio may be 50:50.

According to some embodiments, the granule may further comprise a binder in a concentration of between 0.1-5% w/w.

According to some embodiments, the binder may be selected from the group including binders, such as bentonite, sodium silicate, lignosulfonates, molasses, hydrated lime, bitumen, Portland cement, clay, acids (nitric, hydrochloric, phosphoric, sulphuric), cellulose gum, sucrose, water, water glass, cements, starch or combinations thereof.

According to some embodiments, there is provided herein a method for granulating a fertilizer granule comprising a mixture of polyhalite and melt urea in a ratio of between 20:80 to 80:20, wherein said method comprising: warming urea to over 130° C. to melt the urea, and transferring said melt urea to a mixer;

adding Polyhalite to said mixer in a ratio of 20:80 to 80:20 with the melt urea, and mixing to yield a mixture;

lowering the temperature of the mixture to about 30-70° C.; and transferring said mixture to a Drum granulator for 3-5 minutes, to yield granules.

According to some embodiments, the granules may further undergo a sieving process to yield a desirable size granule at a size range of 2-5.6 mm.

### DETAILED DESCRIPTION OF THE INVENTION

According to some demonstrative embodiments, there is provided herein a chloride free fertilizer granule comprising a mixture of polyhalite and melt urea in a ratio of between 20:80 to 80:20.

According to some demonstrative embodiments, the preferred ratio may be 50:50.

According to some demonstrative embodiments, a number of cash crops, such as vegetables, fruits, nuts and field crops, are known for their sensitivity to chloride. Chloride toxicity is expressed in the affected plants as leaf scorching. When the chloride concentration in the soil solution increases, plants take up chloride on the account of essential anionic nutrients, and this may result in reduced crop yield and quality.

According to some embodiments, previous attempts have been made to try and coat urea when used in a fertilizer, in various ways to try and diminish the loss of product.

According to some demonstrative embodiments, there is provided herein a chloride free fertilizer granule comprising a mixture of polyhalite and melt urea in a ratio of between 1:4 to 4:1

According to some demonstrative embodiments, an in contrast to various attempts to coat urea, the present invention utilizes melted urea in the granule. According to some embodiments, it is reasonable that the present invention substantially reduces urea loss and allows for a more homogeneous supply of the nutrients to the plants, with no segregation and more control on the dissolution of the urea.

According to some embodiments, the granule of the present invention may further include one or more additional fertilizers, for example, selected from the group including any material of natural or synthetic origin that is applied to soils or to plant tissues to supply one or more plant nutrients essential to the growth of plants, including, for example, Single nutrient (“straight”) fertilizers such as Ammonium nitrate, Urea, calcium ammonium nitrate, superphosphate, e.g., “Single superphosphate” (SSP), phosphogypsum, Triple superphosphate (TSP) or a mixture thereof; Multinutrient fertilizers such as Binary (NP, NK, PK) fertilizers, e.g., monoammonium phosphate (MAP) and/or diammonium phosphate (DAP), NPK fertilizers which are three-component fertilizers providing nitrogen, phosphorus, and potassium; fertilizers which include one or more of the main micronutrients sources of iron, manganese, boron, molybdenum, zinc, and copper and the like; Compound fertilizers, e.g., which contain N, P, and K; Organic fertilizers such as peat, animal wastes, plant wastes from agriculture, and sewage sludge; and/or Other elements such as calcium, magnesium, and sulfur.

According to some embodiments, the granule may further comprise a binder in a concentration of between 0.1-5% w/w.

According to some embodiments, the binder may optionally be selected from the group including binders, such as starch, bentonite, sodium silicate, lignosulfonates, molasses, hydrated lime, bitumen, Portland cement, clay, acids (nitric, hydrochloric, phosphoric, sulphuric), cellulose gum, sucrose, water, water glass, cements, or combinations thereof.

According to some embodiments, the binder may preferably be selected from the group including: Starch, activated starch, whether alone or in combination with potassium silicate; meta kaolin; potassium silicate; sodium silicate or a combination thereof.

According to some demonstrative embodiments, there is provided herein a method for granulating a fertilizer granule comprising a mixture of polyhalite and melt urea in a ratio of between 20:80 to 80:20 wherein said granule is granulated in drum to produce N,K, Ca, Mg, S complex fertilizer chloride free.

Urea melt can also be granulated with: kieserite, langbeinite kainite potash. SOP in the same procedure as described herein with regard to polyhalite. According to some embodiments, the method may comprise warming urea to over 130° C. to melt the urea. The melted urea may be transferred to a mixer, granulator. According to some embodiments, polyhalite may be added to the mixer to yield a mixture and the mixture may be mixed for a few minutes, e.g., 3-4 minutes. According to some embodiments, the ratio between the melted urea and Polyhalite may be 20:80 to 80:20, preferably 50:50, e.g. 50% melt urea and 50% polyhalite.

According to some embodiments the temperature of the mixture may then be reduced to about 30-70° C.

According to some embodiments, the mixture may be transferred to a granulator for 3-5 minutes, to yield granules.

According to some embodiments, the granulation process may be conducted using various machines like a pan granulator, Drum, a Plough shear mixer and/or granulator and the like.

According to some embodiments, the granulator is preferably a drum granulator.

According to some embodiments, the granules may undergo a sieving process to yield a desirable size granule at a size range of 2-5.6 mm, preferably 2-4.75 mm.

According to some embodiments, any undersized granules may be returned to the mixer, and any oversized granules may be ground and transferred to the mixer for further processing.

According to some embodiments, the desired size granules may be further dried and cooled to yield the final product.

According to some embodiments, the resulting granule may be coated with one or more coatings, organic or inorganic coating e.g., to enable the delayed release of the materials of the granule or to add additional components to the fertilizer granule.

### Example 1

800 gr of urea was melted at 140 degree and 200 gr of polyhalite-2 mm was added in laboratory scale granulated.

After cooling the granules were tested:

Abrasion of granule 0.87%

Strength of granules 1.7 kg/granules

### Example 2

### Conditions as in Example 1

200 gr of urea was melted and 800 gr of polyhalite was added to the mixture and granulated.

Results:

Abrasion of granule 3.5%

Strength of granules 3 kg/granules

### Example 3

A continues experiment was conducted.

500 kg of urea was melted and 500 kg of polyhalite was added to the mixture.

The proportion between product and re circulated stream was 1:2.5

Product composition N, P, K 25:0:6

SG was 310 micron

Abrasion—0.5%

Strength—1.7—Kg/granule

### Example 4

### Test Conditions

A continuous experiment was conducted to manufacture Polyhalite and melt urea granules.

The Polyhalite was mixed with the urea and fed into a granulator. The granulated product exiting the granulator was transferred to a dryer to undergo a drying process to yield dry granules.

The dry granules were then transferred for screening.

The desired granule size is between 2-4.75 mm, whereas granules having a smaller diameter than 2 mm were transferred back to the granulator, granules having a diameter of more than 4.75 mm were subject to milling and/or crushing and fed back to the feed.

The resulting product was subjected to chemical and physical tests, particle size distribution, uniformity, granule strength and abrasion tests.

After the pilot reached a steady state, the granules were tested every 30 minutes.

Polyhalite was fed at a rate of 11 kg/hour with a 93% solution of melt urea which was fed at a rate of 12 kg/hour.

Conditions of the experiment:

Temperature 36° C.

Granulator speed 22 RPM

Recycle ratio is 5.1

Granules discharge from dryer at 50° C. and after cooldown the granules composition is

| Total-N | K2O | Total-S | CaO | MgO |
|---|---|---|---|---|
| 24.7 | 6.1 | 8.6 | 8.4 | 3.2 |

Uniformity index-55

PSD >95%

Size—between 2-4.75 MM

Crushing strength 0.65-2.15 Kg/granule. Average 1.26 Kg/granule.

After drying 1 hour the granule strength is between 0.7-2.2 Kg/ granule.

Average strength 1.4 Kg/granule

CRH is 60-65

Abrasion 0.5%.

### Example 5

Polyhalite was fed at a rate of 11 kg/hour with a 93% solution of melt urea which was fed at a rate of 12 kg/hour.

Conditions of the experiment:

Temperature 36° C.

Granulator speed 22 RPM

Recycle ratio is 2.1

Granules discharge from dryer at 48° C. and after cooldown the granules composition is

| Total-N | K2O | Total-S | CaO | MgO |
|---|---|---|---|---|
| 24.8 | 5.8 | 8.6 | 8.3 | 3.1 |

Uniformity index-55

PSD >95%

Size—between 2-4.75 MM

Crushing strength 0.65-1.5 Kg/granule. Average 0.88 Kg/granule.

After drying 1 hour granule strength between 1.2-2.2 Kg/ granule. Average strength 1.7 Kg/granule

CRH is 60-65

Abrasion 0.5%.

1. A fertilizer granule comprising a mixture of polyhalite and melt urea in a ratio of between 20:80 to 80:20

2. The granule of claim 1, wherein said ratio is 50:50.

3. The granule of claim 1, further comprising a binder in a concentration of between 0.1-5% w/w.

4. The granule of claim 3, wherein said binder is selected from the group including binders, such as bentonite, sodium silicate, lignosulfonates, molasses, hydrated lime, bitumen, Portland cement, clay, acids (nitric, hydrochloric, phosphoric, sulphuric), cellulose gum, sucrose, water, water glass, cements, starch or combinations thereof.

5. A method for granulating a fertilizer granule comprising a mixture of polyhalite and melt urea in a ratio of between 20:80 to 80:20, wherein said method comprising:
warming urea to over 130° C. to melt the urea, and transferring said melt urea to a mixer;
adding Polyhalite to said mixer in a ratio of 20:80 to 80:20 with the melt urea, and mixing to yield a mixture;
lowering the temperature of the mixture to about 30-70° C.; and
transferring said mixture to a Drum granulator for 3-5 minutes, to yield granules.

6. The method of claim 5, wherein said granules further undergo a sieving process to yield a desirable size granule at a size range of 2-5.6 mm.
